(19) United States
(12) Patent Application Publication
(10) Pub. No.: US 2020/0398835 A1
(43) Pub. Date: Dec. 24, 2020

(54) Method for Creating a Traffic Information Collection, Traffic Information Collection, Collection Unit Having a Traffic Information Collection, and Driver Assistance Unit

(71) Applicant: Vitesco Technologies GmbH, Hannover (DE)

(72) Inventors: Friedrich Graf, München (DE); Stefan Grubwinkler, München (DE)

(73) Assignee: Vitesco Technologies GmbH, Hannover (DE)

(21) Appl. No.: 16/763,843

(22) PCT Filed: Nov. 14, 2018
(86) PCT No.: PCT/EP2018/081213

§ 371 Date: Aug. 3, 2020

(30) Foreign Application Priority Data
Nov. 16, 2017 (DE) 10 2017 220 420.6

(51) Int. Cl. B60W 30/14; B60W 40/04

(52) U.S. Cl. CPC B60W 30/143; B60W 2554/406; B60W 2556/45; B60W 40/04

(57) ABSTRACT

Various embodiments include a method for operating a motor vehicle using a collection of traffic information comprising: detecting a position of a first vehicle and a corresponding time; transmitting the position and time to an off-board collecting device; determining a future speed profile of the first vehicle; transmitting the future speed profile to the collecting device; generating the collection of traffic information based on the position, the time, and the future speed profile; transmitting the the collection of traffic information to a second vehicle; and operating the second vehicle based on the position, the time, and the future speed profile of the first vehicle.

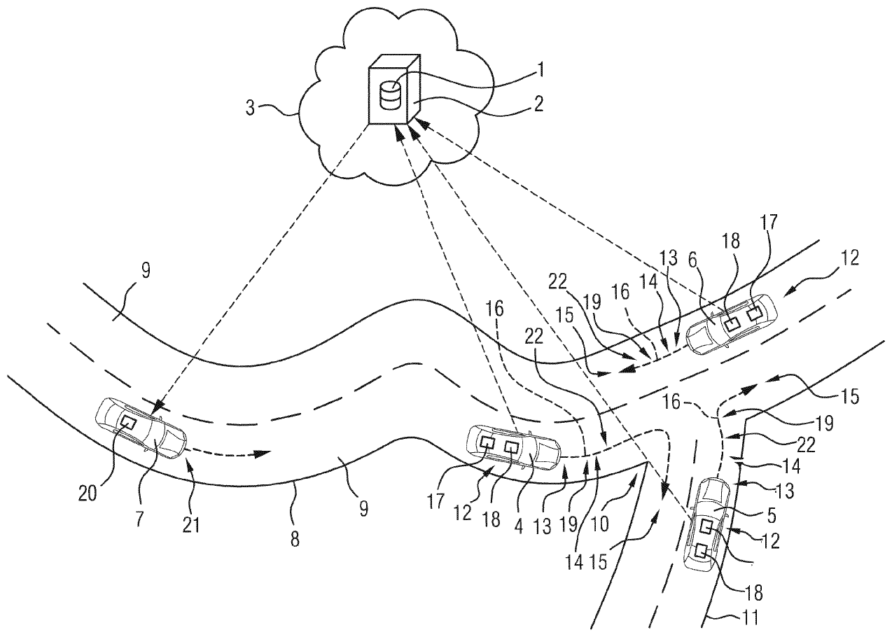

### CROSS-REFERENCE TO RELATED APPLICATIONS

This application is a U.S. National Stage Application of International Application No. PCT/EP2018/081213 filed Nov. 14, 2018, which designates the United States of America, and claims priority to DE Application No. 10 2017 220 420.6 filed Nov. 16, 2017, the contents of which are hereby incorporated by reference in their entirety.

### TECHNICAL FIELD

The present disclosure relates to collecting traffic information.

### BACKGROUND

In some methods for collecting traffic information, a current position and a current time of a motor vehicle are detected in order to be transmitted to an off-board collecting device. For example, a roadmap can then be produced on the basis of the position and the time if the position and the time of a plurality of vehicles are detected and transmitted. For example, a traffic jam can then be detected on the basis of the roadmap. However, in known methods it has previously not been customary for a future position of the motor vehicle or motor vehicles to be determined and for the roadmap then to be generated, for example, on the basis of the future traffic information.

### SUMMARY

The teachings of the present disclosure include methods, for collection of traffic information, collecting devices, and driver assistance devices with which a motor vehicle can be operated more energy-efficiently. For example, some embodiments include a method for generating a collection of traffic information (1), in which the following steps are carried out: detection of a current position (12) of a motor vehicle (4, 5, 6); detection of a current time (13) at which the position (12) is detected; transmission of the position (12) and the time (13) to an off-board collecting device (2); determination of a future speed profile (14) of the motor vehicle (4, 5, 6) by the motor vehicle (4, 5, 6); transmission of the future speed profile (14) to the collecting device (2); and generation of the collection of traffic information (1) on the basis of the position (12), the time (13) and the future speed profile (14), characterized in that the position (12), the time (13) and the future speed profile (14) are transmitted from the collection of traffic information (1) to a further motor vehicle (7) and the further motor vehicle (7) is operated in accordance with the position (12), the time (13) and the future speed profile (14).

In some embodiments, a speed (21) of the further motor vehicle (7) is adapted in accordance with the position (12), the time (13) and the future speed profile (14).

In some embodiments, the future speed profile (14) is determined with a prediction horizon (22) of at least several hundred meters.

In some embodiments, the future speed profile (14) is determined on the basis of a setting of a cruise control system (17) of the motor vehicle (4, 5, 6).

In some embodiments, the future speed profile (17) is determined on the basis of a speed specification by a driver assistance device (18) of the motor vehicle (4, 5, 6), which driver assistance device (18) makes available information about energy-efficient vehicle control of the motor vehicle (4, 5, 6).

In some embodiments, the motor vehicle (4, 5, 6) is operated autonomously, and the future speed profile (14) is determined on the basis of trajectory planning (19) for the autonomous operation of the motor vehicle (4, 5, 6).

In some embodiments, traffic congestion information is acquired and the collection of traffic information (1) is generated on the basis of the traffic congestion information.

In some embodiments, condition of the roadway of a road (8) on which the motor vehicle (4, 5, 6) is located is detected and the collection of traffic information (1) is generated on the basis of the condition of the roadway.

As another example, some embodiments include a collection of traffic information (1) having a position (12) of at least one motor vehicle, a time (13) at the position (12) and a future speed profile (14) of the motor vehicle (4, 5, 6), characterized in that the collection of traffic information is configured in such a way that the position (12), the time (13) and the future speed profile (14) are translated from the collection of traffic information (1) to a further motor vehicle (7), wherein the further motor vehicle (7) is operated in accordance with the position (12), the time (13) and the future speed profile (14).

As another example, some embodiments include a collecting device (2) having a collection of traffic information (1) as described herein, which collecting device (12) is configured to transmit the collection of traffic information (1) at least partially to a further motor vehicle (7).

As another example, some embodiments include a driver assistance device (20) for a further motor vehicle (7), which is configured to adapt a speed (21) of the further motor vehicle (7) on the basis of a position (12) of a motor vehicle, (4, 5, 6), a time (13) at the position (12) and a future speed profile (14) of the motor vehicle (4, 5, 6).

In some embodiments, the device is also configured to determine or adapt a speed (21) of the further motor vehicle (7) on the basis of a future route (16) from the first motor vehicle (4).

In some embodiments, the motor vehicle (4, 5, 6) is operated autonomously, and the future speed profile (14) is determined on the basis of trajectory planning (19) for the autonomous operation of the motor vehicle (4, 5, 6).

In some embodiments, the future speed profile (14) is adapted by means of traffic congestion information.

### BRIEF DESCRIPTION OF THE DRAWINGS

Exemplary embodiments of the teachings herein are explained in more detail below on the basis of schematic drawing.

The FIGURE shows a schematic profile of an exemplary embodiment of a method incorporating the teachings herein for generating a collection of traffic information.

### DETAILED DESCRIPTION

In some embodiments, a collection of traffic information is generated. The following steps are carried out:
detection of a current position of a motor vehicle, particularly by the motor vehicle;
detection of a current time at which the position is detected, particularly by the motor vehicle;
transmission of the position and of the time to an off-board collecting device, particularly by the motor vehicle;
determination of a future speed profile of the motor vehicle by the motor vehicle, particularly starting from the position;
transmission of the future speed profile to the collecting device, particularly by the motor vehicle; and
generation of the collection of traffic information, particularly in the collecting device, on the basis of the position, the time and the future speed profile.

The future speed profile can be determined and can be stored together with the position and the time in the collection of traffic information. The collection traffic information as a result can then make available traffic information about a future position of the motor vehicle and, particularly, a future trajectory profile of the motor vehicle. This is advantageous since, for example, a further motor vehicle can use the collection of traffic information with the future speed profile in order to adapt its operation thereto.

In some embodiments, the collection of traffic information is generated with the respective position, the respective time and the respective future speed profile in a plurality of motor vehicles. The further motor vehicle can then adapt and plan ahead its speed and/or its route on the basis of the future positions of the motor vehicle. The further motor vehicle can as result be operated more safely and energy-efficiently.

In some embodiments, the further motor vehicle infers from the collection of traffic information that in 3 km a vehicle will appear with a cruise control system setting of 80 km/h on the country road in front of the further motor vehicle. The country road has a speed limit of 100 km/h but the vehicle is moving at 80 km/h owing to the cruise control system. The further motor vehicle therefore detects, on the basis of the collection of traffic information, that driving at a maximum speed results in said motor vehicle having to drive at 80 km/h behind the vehicle after this 3 km. It may therefore be more appropriate for the further motor vehicle to drive more slowly and with greater savings in terms of energy so that, for example, it does not arrive behind the vehicle until said vehicle leaves the country road or else at this point the country road changes from one lane to two lanes and therefore the possibility of overtaking the vehicle is provided.

The future speed profile describes what speeds the motor vehicle will move in future, particularly starting from the position or starting from the time. By means of the future speed profile it is possible to predict what position the motor vehicle will be in at a future time. By means of the future speed profile it is therefore possible to predict when the motor vehicle will be at which location in future.

In some embodiments, in addition to the future speed profile the motor vehicle also determines a future route or route trajectory, which is also transmitted to the collecting device. By determining the future route trajectory, for example a future position of the motor vehicle can then also be determined if a road on which the motor vehicle is currently moving, splits, for example as a result of an intersection, and two possible continuing roads are options for the motor vehicle. The future trajectory or the future route of the motor vehicle can be used to determine the probable location or the probable future position of the motor vehicle more accurately. Without the future route, it is provisionally assumed that the motor vehicle follows the current road without making a turn or turning around.

In some embodiments, the position, the time, and the future speed profile are transmitted from the collection of traffic information to a further motor vehicle, and the further motor vehicle is operated in accordance with the position, that time and the future speed profile. The further motor vehicle can as a result be operated more predictably. In this, the further motor vehicle can, for example, adapt its planned route or else adapt its speed or else plan an energy charging stop in accordance with the future position of the motor vehicle. The future position of the motor vehicle is determined, particularly, on the basis of the position, the time and the future speed profile.

In some embodiments, a speed of the further motor vehicle is adapted in accordance with the position, the time and the future speed profile. The speed of the further motor vehicle can be increased, for example, if it is detected on the basis of the collection of traffic information that a relatively slow vehicle, for example a truck or a heavy load will turn onto the road on which the travel route of the further motor vehicle extends. The speed can, however, also be reduced if a relatively slow vehicle which currently cannot yet be overtaken is already traveling a few kilometers in front of the further motor vehicle. The further motor vehicle can then be operated, for example, at a speed with a better efficiency level.

In some embodiments, the future speed profile is determined with a prediction horizon of at least several hundred meters. By means of the prediction horizon it is predefined, particularly, how far the future position of the motor vehicle can be determined on the basis of the future speed profile. Through the prediction horizon of the at least several hundred meters, the further motor vehicle itself can then profit from the future position of the motor vehicle if said motor vehicle is not (yet) in sight. By virtue of the prediction horizon of at least several hundred meters, the further motor vehicle can also be operated more energy-efficiently and safely. However, it may also be the case that the future speed profile is determined with a prediction horizon of at least several kilometers. As a result, the further motor vehicle can be operated once more in a more energy efficient and safe fashion.

In some embodiments, the future speed profile is determined on the basis of a setting of a cruise control system of the motor vehicle. The cruise control system, which is also known as an ACC (adaptive cruise control) system denotes a device of the motor vehicle which automatically regulates a rotational speed of an engine of the motor vehicle and, for example, a transmission setting of the motor vehicle that maintains a predefined speed where possible. The speed of the cruise control system can be predefined, for example, by a driver of the motor vehicle. The cruise control system can be set, for example, to 100 km/h, as a result of which it can then be assumed for the first time that the future speed profile is at 100 km/h, particularly at least as far as the next road sign or as far as the next obstacle. The cruise control system permits the future speed profile to be determined precisely and reliably.

In some embodiments, the future speed profile is determined on the basis of a speed specification of a driver assistance device of the motor vehicle, which driver assistance device makes available information about energy-efficient vehicle control of the motor vehicle. The driver assistance device is used, for example, to calculate speed planning and trajectory planning of the motor vehicle which are optimum in terms of energy. In this way, the driver assistance device can output, for example, to a driver of the motor vehicle the information as to how the motor vehicle can be controlled more energy-efficiently. In this way, a gearshift suggestion or a speed suggestion or a steering suggestion can be output as the information.

In some embodiments, the motor vehicle is operated autonomously and the future speed profile is determined on the basis of trajectory planning for the autonomous operation of the motor vehicle. For the autonomous operation of the motor vehicle a trajectory or a route trajectory planned in order to know which control operation, for example speed control operation and/or steering control operation has to be performed in order to operate the autonomous motor vehicle safely. This trajectory planning of the motor vehicle is used in turn to determine the future speed profile of the motor vehicle The future speed profile can be determined accurately and reliably on the basis of the trajectory planning of the motor vehicle.

In some embodiments, traffic congestion information is detected and the collection of traffic information is generated on the basis of the traffic congestion information. A traffic jam which is located, particularly, ahead of the motor vehicle is described by the traffic congestion information. The traffic jam or traffic congestion is a flow of traffic which is very slow-moving or has come to a standstill on a road. One of the reasons for this is an excessively high number of vehicles per unit of time (or per distance length). However, traffic jams can also occur even though the capacity of the road is sufficient given uniformly distributed and flowing traffic. For example, the length of the traffic jam or the additional travel time, the cause of the traffic jam or the anticipated chronological end of the traffic jam or positional end of the traffic jam which lies for example, just before or just after an entry slip road or exit slip road can be detected as the traffic congestion information. The future speed profile can be adapted by means of the traffic congestion information and the future position of the motor vehicle can as a result be in turn determined more accurately.

In some embodiments, the condition of the roadway of a road on which the motor vehicle is located is detected, particularly by the motor vehicle, and the collection of traffic information is generated on the basis of the condition of the roadway. For example, a coefficient of friction of the road, which is for example, weather-dependent or temperature-dependent, can be detected as the condition of the roadway. The coefficient of friction can therefore be different, for example in the case of black ice, wet conditions or fog. The future speed profile can be adapted by means of the roadway information and the future position of the motor vehicle can as a result be in turn determined more accurately.

Some embodiments include a collection of traffic information. The collection of traffic information of at least one motor vehicle has a position of the motor vehicle, a time of the position and a future speed profile of the motor vehicle. In some embodiments, the collection of traffic information is embodied as database, particularly for mass data (big data). In some embodiments, the collection of traffic information is kept available in an off-board collecting device, but can also be translated completely from the collecting device to a further motor vehicle. Particularly, the collection of traffic information has respectively the position, the time, and the future speed profile of a plurality of vehicles. The collection of traffic information can then be used, for example, to generate a road map on which future positions, which have been respectively determined on the basis of the position, the time and the future speed profile, are represented.

Some embodiments include a collecting device with a collection of traffic information according to the invention. The collecting device is configured to transmit the collection of traffic information at least partially, that is to say, for example, the position, the time and the future speed profile or directly the future position of the motor vehicle to a further motor vehicle. In some embodiments, the collection of traffic information is transmitted only for the catchment area of the further motor vehicle, and therefore, for example, only the information from the collection of traffic information which originates from motor vehicles which are, for example, at a specific distance from the other motor vehicle, are transmitted to the further motor vehicle.

In some embodiments, the collecting device comprises, for example, as a server here. The server can be connected, for example, to the Internet and be embodied as a central server or else as a distributed system or computer cloud. In some embodiments, the collecting device can also determine a future position of the motor vehicle on the basis of the position, the time and the future speed profile of the motor vehicle. It is then possible, for example, also to transmit only the future position of the motor vehicle to the further motor vehicle.

Some embodiments include a driver assistance device for a further motor vehicle. The driver assistance device is designed to adapt a speed of the further motor vehicle on the basis of a position of a motor vehicle, a time at the position and a future speed profile of the motor vehicle. By means of the driver assistance device it is possible therefore to operate the further motor vehicle in accordance with the future speed profile of the motor vehicle. In this context, the driver assistance device can evaluate, particularly, the future speed profile of a future position of the motor vehicle and use said profile or position to operate the further motor vehicle. Therefore, the speed of the further motor vehicle is adapted, for example by the driver assistance device, if it becomes apparent from the future speed profile of the motor vehicle that the further motor vehicle is impeded by the motor vehicle if the speed of the further motor vehicle is not adapted. The further motor vehicle may comprise an electric vehicle or hybrid electric motor vehicle.

In some embodiments, the future speed profile can also be determined by the further vehicle. The further motor vehicle can as a result use the collection of traffic information and adapted it at the same time.

Advantages of the methods taught herein are to be considered analogous to advantages of the collection of traffic information, of the collecting device, and of the driver assistance system. The subject-matter-forming components of the collection of traffic information, of the collecting device and the driver assistance device are each designed to carry out the respective method steps. Further features of the teachings herein emerge from the claims, the FIGURE and the description of the FIGURE.

The FIGURE shows an exemplary embodiment for generating a collection of traffic information 1. According to the exemplary embodiment, the collection of traffic information 1 comprises a database and is arranged in a collecting device 2. According to the exemplary embodiment, the collecting device 2 is embodied as a server which is in turn present in the form of a computer cloud 3 (cloud computing).

Furthermore, the FIGURE shows a first motor vehicle 4, a second motor vehicle 5, a third motor vehicle 6 and a further motor vehicle 7. According to the exemplary embodiment, the first motor vehicle 4, the second motor vehicle 5, the third motor vehicle 6 and the further motor vehicle 7 are located on a road 8 which has one lane 9 in each direction and a T junction 10. At the T-junction 10, a further road 11 branches off from the road 8 and leads into the road 8. The second motor vehicle 5 is currently still traveling on the further road 11.

An exemplary embodiment of the method proceeds as follows. The method is described on the basis of the first motor vehicle 4. However, the method sequence for the second motor vehicle 5 and the third motor vehicle 6 is analogous to that for the first motor vehicle 4. A current position 12 of the first motor vehicle 4 is detected by the first motor vehicle 4. The current position 12 can be detected for example, with a global navigation satellite system (GNNS). It is also possible, for example, to use a relative GNSS in order to detect the current position 12 more accurately. Particularly, the first motor vehicle 4 will have the GNSS.

Furthermore, a current time 13 is detected by the first motor vehicle 4. The current time 13 corresponds to the time at which the current position 12 is detected. The time 13 is, particularly, a time specification but can also additionally comprise a date specification.

After detection of the position 12 and of the time 13, the position 12 and the time 13 are transmitted to the collecting device 2. The transmission of the position 12 and of the time 13 to the collecting device 2 is carried out, particularly, by the first motor vehicle 4. The transmission can be carried out, for example, by means of a mobile radio data network or in a variety of wireless ways.

According to the exemplary embodiment, a future speed profile 14 of the first motor vehicle 4 is also determined in addition to the detection of the position 12 and of the time 13. According to the exemplary embodiment, the future speed profile 14 is determined starting from the time 13. The future speed profile 14 describes the speeds at which the first motor vehicle 4 is expected to move from the current position 12 to a future position. The speed can change over various route segments here. By means of the future speed profile 14 it is therefore also possible to predict or estimate or determine a future position 15 of the first motor vehicle 4.

The first motor vehicle 4 may also determine a future route 16 in addition to the future speed profile 14. The future route 16 describes which road the first motor vehicle 4 is expected to use in the future. By means of the future route 16 it is possible, for example, also to determine the future position 15 more reliably if the first motor vehicle 4 turns off from the road 8 into the further road 11 and does not continue to travel on the road 8. The future route 16 can be determined, for example, on the basis of a setting of a navigation device of the first motor vehicle 4.

According to the exemplary embodiment, the future speed profile 14 is determined on the basis of a setting of a cruise control system 17 and/or of a speed specification of a driver assistance device 18 of the first motor vehicle 4 and/or trajectory planning 19 of the first motor vehicle 4, particularly if the first motor vehicle 4 is operated autonomously.

According to the exemplary embodiment, the first motor vehicle 4 transmits the future speed profile 14, together with the position 12 and the time 13, to the collecting device 2. The transmission is preferably carried out in a wireless fashion, as previously described above.

Furthermore, according to the exemplary embodiment, the collection of traffic information 1 is generated in the collecting device 2 on the basis of the position 12, the time 13 and the future speed profile 14. The future route 16 is preferably also transmitted to the collecting device 2, and the collection of traffic information 1 is also generated on the basis of the future route 16. The future position 15 of the first motor vehicle 4 can then be determined on the basis of the collection of traffic information 1.

According to the exemplary embodiment, the collection of traffic information 1 and/or the future position 15 of the first motor vehicle 4 are/is used by the further motor vehicle 7. For this purpose, the future position 15 and/or the position 12, the time 13 and the future speed profile 14 transmitted from the collecting device 2 to the further motor vehicle 7. According to the exemplary embodiment, the further motor vehicle 7 has a driver assistance device 20. The driver assistance device 20 can evaluate the future position 15 of the first motor vehicle 4 and/or the position 12, the time 13 and the future speed profile 14 of the first motor vehicle 4 to determine whether a speed 21 of the further motor vehicle 7 is adapted. Therefore, by means of the driver assistance device 20 the further motor vehicle 7 can be operated more energy-efficiently and more safely with respect to the first motor vehicle 4.

Therefore, for example in several hundred meters the first motor vehicle 4 can turn off from the road 8 into the further road 11. If the first motor vehicle 4 is traveling more slowly than the further motor vehicle 7, the further motor vehicle 7 would have to brake when the first motor vehicle 4 is reached, and would therefore lose energy, or the further motor vehicle 7 would travel more quickly even though it is then actually impeded by the first motor vehicle 4 and has to travel more slowly. The operation of the further motor vehicle 7 would be more energy efficient if the further motor vehicle 7 travels at precisely such a speed that the further motor vehicle 7 reaches the first motor vehicle 4 at this position at which the first motor vehicle 4 turns off into the further road 11. The further motor vehicle 7 then no longer needs to brake and can travel more energy-efficiently until the first motor vehicle 4 is reached, but nevertheless said further motor vehicle 7 can arrive at its destination at the same time as if it has traveled behind the first motor vehicle 4.

According to the exemplary embodiment, the future speed profile 14 is determined with a prediction horizon 22 of at least several hundred meters. By virtue of the prediction horizon 22, the further motor vehicle 7 can therefore learn early enough that the first motor vehicle 4 intends to turn off into the further road 11 at several hundred meters from the road 8. Since the further motor vehicle 7 intends to carry on traveling on the road 8 and not to turn into the further road 11, it is therefore worthwhile for it to travel only at such a speed that it reaches the first motor vehicle 4 as it turns off into the further road 11 and not earlier, that is to say before said first motor vehicle 4 turns off into the further road 1.

Therefore, each motor vehicle 4, 5, 6, 7 has its own efficiency level, and for each motor vehicle 4, 5, 6, 7 a different speed can mean a different efficiency level. The first motor vehicle 4 has, for example, a different efficiency level from the further motor vehicle 7. If the further motor vehicle 7 is therefore traveling behind the motor vehicle 4, it cannot utilise its own efficiency level to an optimum degree if it has to follow the first motor vehicle 4.

In some embodiments, the further motor vehicle 7 receives the respective position 12 and the respective time 13 and the respective future speed profile 14 and/or the respective future position 15 only from motor vehicles which are located inside a specific surrounding area. If there are a plurality of motor vehicles traveling ahead in front of the further motor vehicle 7, it is possible to determine on the basis of the distance between the motor vehicles when it is to be expected that the motor vehicles will back up and which motor vehicle will determine the minimum speed of the backed-up traffic.

If there is a motor vehicle coming towards the further motor vehicle 7, such as for example the third motor vehicle 6, it is possible to calculate for how long it is not possible for the further motor vehicle 7 to make an overtaking manoeuvre. For this distance, the speed of the further motor vehicle 7 remains constant. Furthermore, an overtaking manoeuvre of the further motor vehicle 7 can be advised against on the basis of the collection of traffic information 1, since said overtaking manoeuvre is either without benefit or dangerous if, for example, a motor vehicle is approaching on the opposite side, like the third motor vehicle 6. This increases the safety of the further motor vehicle 7 and the third motor vehicle 6. Furthermore, the C02 emissions, the emissions of fine dust particles and/or the emissions of nitrogen oxide by the further motor vehicle 7 are reduced because unnecessary acceleration is avoided.

If a fourth motor vehicle (not illustrated in the FIGURE) is traveling more quickly behind the further motor vehicle 7 than the further motor vehicle 7, the further motor vehicle 7 can be informed, for example, that it is to be expected that it will be overtaken soon by the fourth motor vehicle.

By means of the collection of traffic information 1 it is possible not only to reduce the energy consumption of the further motor vehicle 7 but also its C02 emissions, particle emissions and/or nitrogen oxide emissions.

It is also possible, for example, to carry out predictive provision of power for the drive train of the further motor vehicle 7 by means of an electric machine, for example an additive torque in the case of hybrid-electric vehicles or an overload in the case of electric vehicles through knowledge of the future trajectory profile. It is also possible to make the estimation of the range accurate in the case of electric vehicles or the further motor vehicle 7 on the basis of the collection of traffic information 1.

### LIST OF REFERENCE NUMERALS

1 Collection of traffic information
2 Collecting device
3 Computer cloud
4 First motor vehicle
5 Second motor vehicle
6 Third motor vehicle
7 Further motor vehicle
8 Road
9 Lane
10 T junction
11 Further road
12 Current position
13 Current time
14 Future speed profile
15 Future position
16 Future route
17 Cruise control system
18 Driver assistance apparatus
19 Trajectory planning
20 Driver assistance device
21 Speed of the further motor vehicle
22 Prediction horizon

What is claimed is:

1. A method for operating a motor vehicle using a collection of traffic information, method comprising:
detecting a current position of a first motor vehicle;
detecting a current time corresponding to the current position;
transmitting the current position and the current time to an off-board collecting device;
determining a future speed profile of the first motor vehicle;
transmitting the future speed profile to the collecting device;
generating the collection of traffic information based on the current position, the current time, and the future speed profile;
transmitting the current position, the current time, and the future speed profile from the collection of traffic information to a second motor vehicle; and
operating the second motor vehicle based on the current position, the current time, and the future speed profile of the first vehicle.

2. The method as claimed in claim 1, wherein operating the second motor vehicle includes setting a speed of the second motor vehicle.

3. The method as claimed in claim 1, wherein the future speed profile is determined with a prediction horizon of at least seven hundred meters.

4. The method as claimed in claim 1, wherein the future speed profile is determined based on setting of a cruise control system of the first motor vehicle.

5. The method as claimed in claim 1, wherein the future speed profile is determined based on a speed specification by a driver assistance device of the first motor vehicle, wherein the driver assistance device makes available information about energy-efficient vehicle control of the first motor vehicle.

6. The method as claimed in claim 1, wherein:
the first motor vehicle comprises a driverless vehicle; and
the future speed profile is determined based on trajectory planning for autonomous operation of the first motor vehicle.

7. The method as claimed in claim 1, further comprising:
acquiring traffic congestion information; and
including the traffic congestion information in the collection of traffic information.

8. The method as claimed in claim 1, further comprising:
detecting a condition of the roadway where the first motor vehicle is located; and
including the condition of the roadway in the collection of traffic information.

9. (canceled)

10. A collecting device comprising:
a memory storing a collection of traffic information including: a position of a first motor vehicle, a corresponding time, and a future speed profile of the first motor vehicle; and
a transmitter providing the collection of traffic information.

11. A driver assistance device for a first motor vehicle, the device comprising:
a receiver configured to receive: a position of a second motor vehicle, a corresponding time, and a future speed profile of the second motor vehicle; and
a processor programmed to control operation of the first motor vehicle based on the position, the time, and the profile.

12. The driver assistance device as claimed in claim 11, wherein the processor is programmed to determine or adapt a speed of the first motor vehicle on the basis of a future route from the second motor vehicle.

13. The driver assistance device as claimed in claim 11, wherein the second motor vehicle comprises a driverless vehicle, and the future speed profile is determined on the basis of trajectory planning for autonomous operation of the second motor vehicle.

14. The driver assistance device as claimed in claim 11, wherein the future speed profile is adapted using traffic congestion information.
